(19) United States
(12) Patent Application Publication
(10) Pub. No.: US 2015/0161720 A1
(43) Pub. Date: Jun. 11, 2015

(54) SYSTEM AND METHOD FOR TRANSMISSION OF FULL MOTION DUPLEX VIDEO IN AN AUCTION

(71) Applicant: Michael J. Maresca, Ramsey, NJ (US)

(72) Inventor: Michael J. Maresca, Ramsey, NJ (US)

(21) Appl. No.: 14/535,974

(22) Filed: Nov. 7, 2014

Related U.S. Application Data
(60) Provisional application No. 61/901,208, filed on Nov. 7, 2013.

(51) Int. Cl. G06Q 30/08; H04N 5/232

(52) U.S. Cl. CPC G06Q 30/08; H04N 5/23222

(57) ABSTRACT

A system for conducting an auction, comprising sending audio/video data recorded at a first location over telephone lines and receiving a reproduction of said audio/video data at a second location, converting said audio/video data at said first location into a stream of packets to be sent over said telephone lines, converting said stream of packets at said second location into said reproduction of said audio/video data to be presented at said second location, and bypassing a telephone company voice switch at a telephone company central office, thereby allowing said stream of packets to pass directly between at least one local telephone line and at least one long distance network.

### CROSS-REFERENCE TO RELATED APPLICATION

This application claims priority to U.S. Provisional Patent Application Ser. No. 61/901,208 filed Nov. 7, 2013, entitled “System and Method for Transmission of Full Motion Duplex Video in an Auction,” the entirety of which is incorporated herein by reference as if set forth herein in its entirety.

### BACKGROUND

1. Field of the Invention

This invention relates to a method and system for online interaction between online merchants, auctioneers, and online auction bidders. Particularly, this invention relates to the visual and audible interaction between online merchants, auctioneers, and bidders. Specifically, the invention relates to a method and system for transmission of full motion duplex video between sellers, auctioneers, and multiple bidders to create an enhanced online auction experience known as a “virtual auction room”.

2. Background of the Invention

Conventional online auctions allow for the transmission of text, photographs, or previously recorded video between online merchants, auctioneers, and online auction bidders. Merchants often provide a text description of inventory in an attempt to gain the interest of buyers and provide information in regards to the inventory. Merchant's use of digital media is another method used for presenting inventory; however the existing media is limited to still photographs or previously recorded video, not a live visual interaction between merchants, auctioneers, and online bidders. Though the conventional form of interaction may be sufficient for certain merchants and purchasers, it is not adequate for large scale or high value item purchases.

The auction industry will, if it chooses, have the ready ability to connect online merchants, auctioneers, and bidders to a “virtual auction room” using compatible computer or mobile devices. Though video conferencing has been around for a number of years, it has not been designed or configured for to enhance the online auction experience or to create a “virtual auction room.” This method of interaction provides merchants and auctioneers the environment needed to interact with potential buyers over the internet via high speed video transfer, provided that each user has one of the devices as outlined below. Through this environment, participants in the online auction industry gain a new more thorough auction experience than previously offered. Prior to the invention of this method, the online auction experience did not allow merchants or an auctioneer to conduct live demonstrations of inventory or visually and audibly interact with the bidders as generally occurs during in person auctions.

### SUMMARY

The present invention includes at least a computer-implemented engine, system and method for allowing the one or more products to be viewed remotely by a plurality of bidders in an online facilitated auction.

### BRIEF DESCRIPTION OF THE DRAWINGS

The accompanying drawings are included to provide a further understanding of the disclosed embodiments. In the drawings, like numerals represent like elements, and:

FIG. 1 illustrates an aspect of an exemplary embodiment of the present invention;

FIG. 2 illustrates an aspect of an exemplary embodiment of the present invention;

FIG. 3 illustrates an aspect of an exemplary embodiment of the present invention;

FIG. 4 illustrates an aspect of an exemplary embodiment of the present invention; and

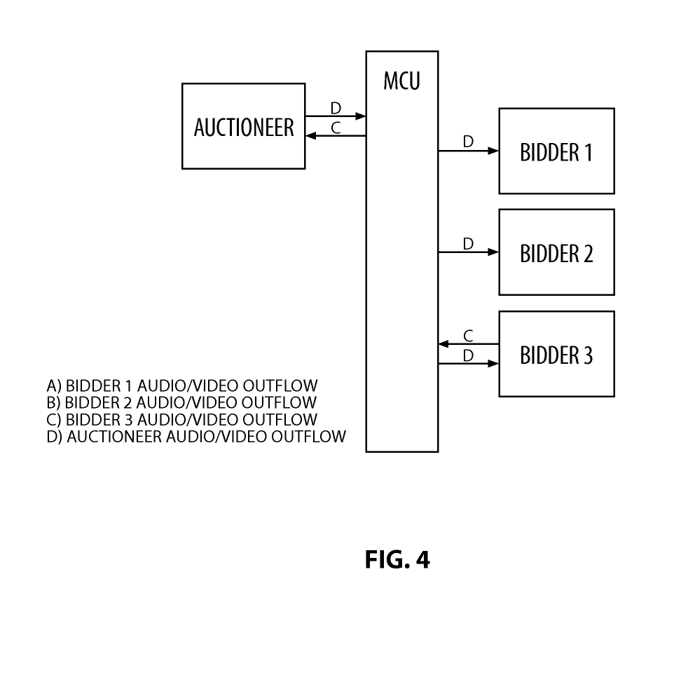

FIG. 5 illustrates an aspect of an exemplary embodiment of the present invention.

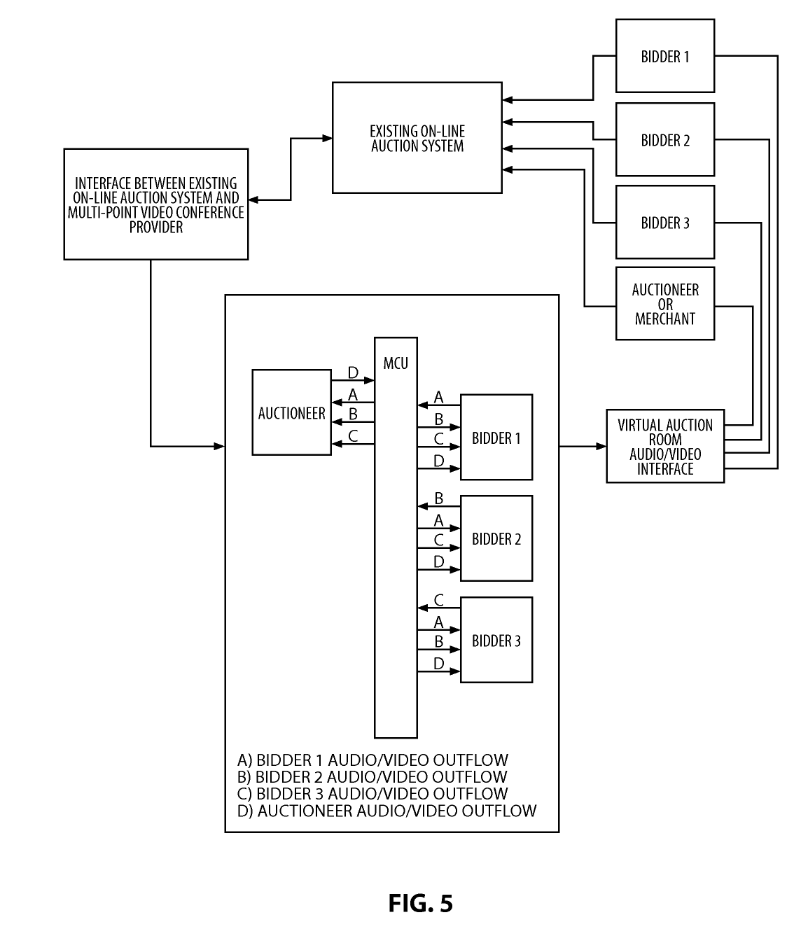

### DETAILED DESCRIPTION

Computer-implemented platforms, engines, systems and methods of use are disclosed that provide networked access to a plurality of types of digital content, including but not limited to video, audio, metadata, interactive and document content, and that track, deliver manipulate, transform and report the accessed content. Described embodiments of these platforms, engines, systems and methods are intended to be exemplary and not limiting. As such, it is contemplated that the herein described systems and methods can be adapted to provide many types of cloud-based valuations, scoring, marketplaces, and the like, and can be extended to provide enhancements and/or additions to the exemplary platforms, engines, systems and methods described. The invention is thus intended to include all such extensions. Reference will now be made in detail to various exemplary and illustrative embodiments of the present invention.

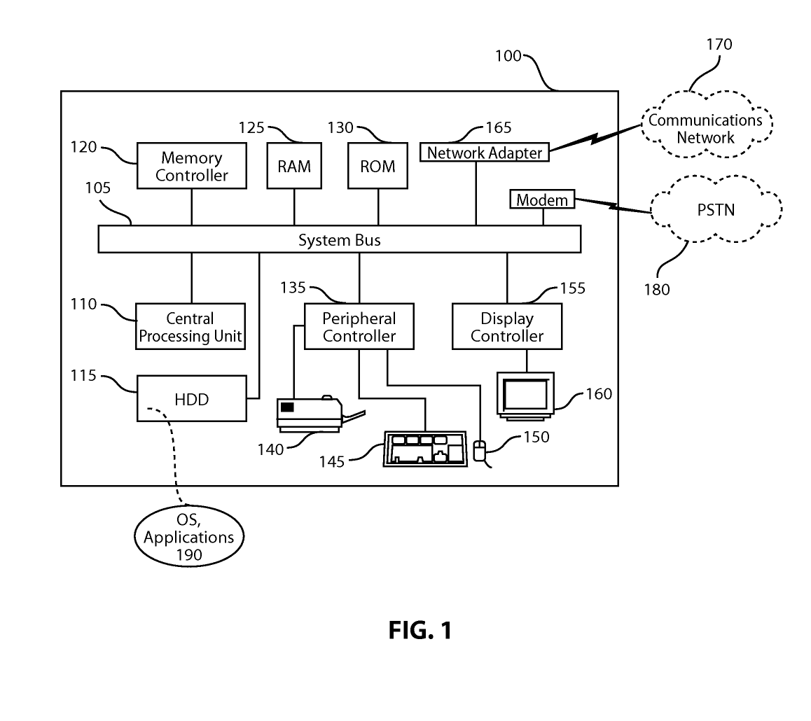

FIG. 1 depicts an exemplary computing system 100 for use in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output and/or presentation generated by or at the request of computing system 100. Such visual output may include text, graphics, animated graphics, and/or video, for example. Display 160 may be implemented with a CRT-based video display, an LCD-based flat-panel display, gas plasma-based flat-panel display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet. Communications network 170 may provide user access for computing system 100 with means of communicating and transferring software and information electronically. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

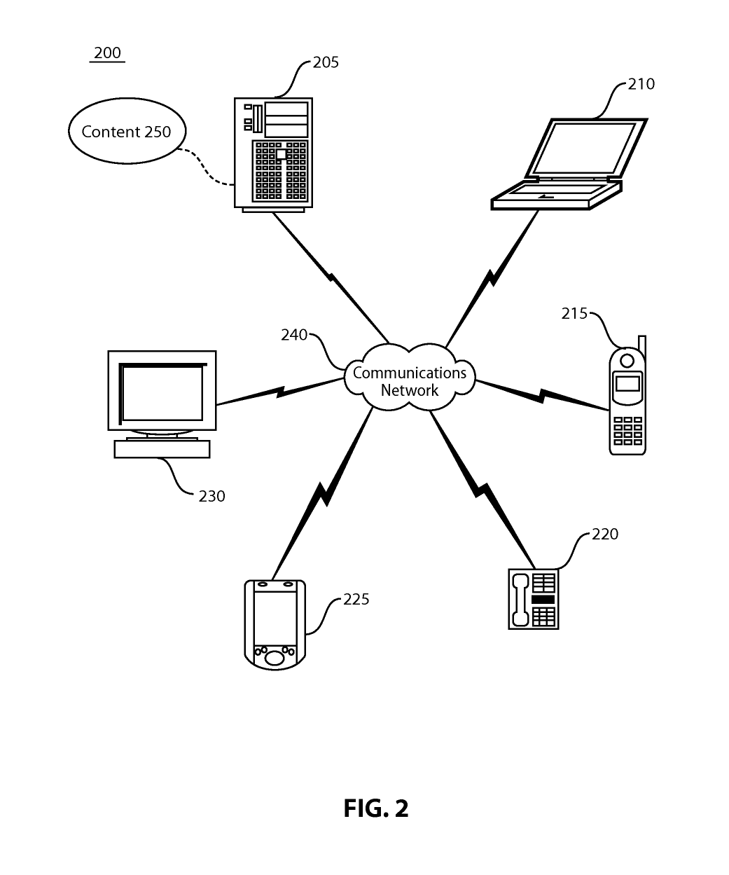

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or the like, to interact with server 205.

The present invention is a method of enhancing online auctions through the facilitation of a “virtual auction room”. The method for created such an environment is through the use of duplex, full motion, multipoint video conferencing. The “virtual auction room” creates a visually and audible interactive environment between merchants, auctioneers, and online bidders. This interaction allows for a more thorough presentation of auction inventory as well as the capability for an enhanced dialogue between all parties. The enhanced visual and audible interaction between auction participants occurs when video, in the form of data, is transmitted through a software portal to a video conferencing provider which is then redistributed to the appropriate parties during an auction format. Once connected to the “virtual auction room”, bidders have the ability to interact with an auctioneer using full motion duplex video and audio captured by each user's computer or mobile device.

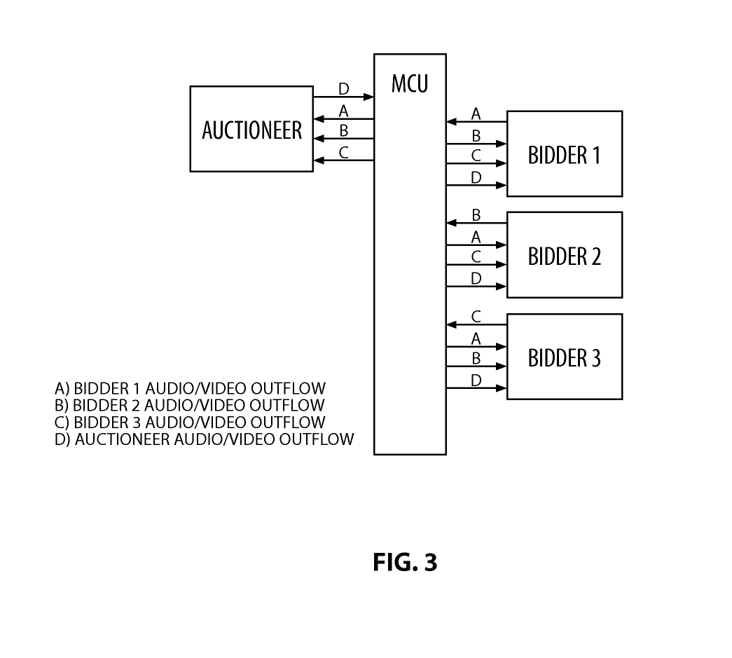

Each participant's audio and video data are captured by the corresponding devices required. Through the use of a software applications, mobile applications or hardware, the audio and video are then transmitted and received by other parties in the manner demonstrated in FIG. 3. As illustrated in FIG. 3 is an illustration of the method and system of this invention showing the flow of video in the form of data between all parties when all users have the devices required for full duplex video and audio interaction.

FIG. 2 is an illustration of the method and system of this invention showing the flow of video audio data between parties when only one of three bidders have the necessary devices as outlined for full motion duplex video and audio interaction. Bidders 1 and 2 can view the auctioneer's presentation video and audio, however they cannot transmit audio and video to the auctioneer. Bidder 3 is able to interact through full motion duplex video and audio. FIG. 3 is an illustration of the method and system of this invention showing the macro scale structure of connections between auction participants, the existing online auction interface, and the video conferencing provide. This illustration demonstrates connection between parties using the previously mentioned interface and structure.

In its full form this invention an auctioneer has the following capabilities 1) transmit and receive data in the form of video and audio between multiple parties 2) present and demonstrate auction inventory and interacts with bidders using a computer as outlined in section A(1), 3) present auction inventory and interact with bidders provided they have a mobile device outlined in Section A(2). In addition to being able to interact with bidders using full motion duplex video, auctioneers will present auction items without bidders being required to transmit data back to the auctioneer. Full motion, unidirectional video is transmitted from the auctioneer to bidders, provided that bidders have a computer as outlined in section B(1) or a mobile device as outlined in B(2) The transmission of video into the virtual environment occurs in the following steps 1) light enters a camera lens and is captured on a charged coupled device, 3) The charge coupled device transfers the digital image information to a video encoding process where the audio and video data are converted into a standards based package, 4) each package is then electronically transferred to a packeting process, 5) the packet is then transmitted electronically using standards based tcpip/udp transmission methodologies for receipt by the remote system 6) the packet is then de-packetized to break the digital information down into a standards based block of digital information 7) the block of information is broken down into raw data which can then be mapped onto a video display [monitor] for viewing by the recipient 8) in the event of multi-party interaction, the raw data is mapped into a large segment video memory block where it is stitched together with raw data from additional sources to create a multiplexed, multi-source display of all participants. The above is also described in WO2000021258, entitled “High speed video transmission over telephone lines” to M. Maresca, which disclosure is incorporated herein by reference and if set forth herein in its entirety. The full motion video is delivered to each end user providing a fully visual auction experience.

The merchant determines the desired time for the visual and audible interaction to occur which determines the time the “virtual auction room” is opened for the online merchant, auctioneer. and online bidders. Once the interaction time is registered by the merchant with the videoconferencing provider, the existing online auction system generates a random number which is registered with the videoconferencing provider. The random number is then sent with a website link via email to participants of a given “virtual auction room.” The website link directs users to an online portal which grants participants access to the appropriate “virtual auction room” provided they have received the random number generated by the existing online auction system.

A(1) Requirements for Participation or Two Way Interaction between an online Auctioneer, Vendor and multiple Bidders using a computer device.

Users may visually and audibly interact with an auctioneer provided that the computer is equipped with A) an internet connection B) web enabled Camera C) computer enabled microphone D) computer monitor or display E) computer enabled speakers E) said device is currently running Microsoft Windows or Mac OS operating system and F) Basic Video Processing Ability.

A(2) Requirements for Participation or Two Way Interaction between an online Auctioneer, Vendor and multiple Bidders using a mobile device.

Users may visually and audibly interact with an auctioneer using a mobile device provided that the mobile device is equipped with A) an internet connection B) web enabled Camera C) a functional microphone D)A functional display E)a functional speakers E) said device is currently running Android of Mac OS operating system and F) Basic Video Processing Ability.

B(1) Requirements for unidirectional viewing of an online Auctioneer without interaction using a computer device.

Users are able to view full motion video and audio being provided by the auctioneer provided that the computer is equipped with A) an internet connection B) web enabled Camera C) computer enabled microphone D) computer monitor or display E) computer enabled speakers E) said device is currently running Microsoft Windows or Mac OS operating system and F) Basic Video Processing Ability.

B(2) Requirements for unidirectional viewing of an online Auctioneer without interaction using a mobile device.

Users can view full motion video and audio being provided by the auctioneer using a mobile device provided that the mobile device is equipped with A) an internet connection B) web enabled Camera C) a functional microphone D)A functional display E)a functional speakers E) said device is currently running Android of Mac OS operating system and F) Basic Video Processing Ability.

Those of skill in the art will appreciate that the herein described systems and methods may be subject to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

1. (canceled)

2. A system for communicating with a plurality of user devices, comprising:
a computing device;
a camera, operatively coupled to the computing device, wherein the camera is configured to capture video and audio data in real time relative to one or more auction items; and
a communications interface, operatively coupled to the computing device, wherein the communications interface is configured to communicate with the plurality of user devices and transmit the captured video and audio data via a computer network,
wherein the computing device is configured to determine characteristics of the user devices, and, depending on the determined characteristic, configure the camera to transmit video and audio data generated by the camera in two-way full motion duplex to at least one of the user devices,
and wherein the communications interface is configured to receive user data relating to the one or more auction items from at least one of the plurality of user devices in response to the transmission.

3. The system of claim 2, wherein the user devices comprise a computer device, and wherein the characteristic comprises one of an internet connection, a web enabled camera, computer enabled microphone, and video processing capability.

4. The system of claim 2, wherein the user devices comprise a mobile device, and wherein the characteristic comprises one of an internet connection, a web enabled camera, functional microphone, and video processing capability.

5. The system of claim 2, wherein the computing device, depending on the determined characteristic, configures the camera to transmit video and audio data generated by the camera in unidirectional full motion duplex to at least one of the user devices.

6. The system of claim 2, wherein the user data relating to the one or more auction items comprises bidding data.

7. The system of claim 2, wherein the communications interface is configured to transmit user data among each of the plurality of user devices.

8. The system of claim 2, wherein the computer network comprises a packet-oriented network.

9. A processor-based method for communicating with a plurality of user devices via a computer system, comprising:
capturing, via a camera coupled to a computing device, video and audio data in real time relative to one or more auction items for transmission via a communications interface;
determining characteristics of the user devices via the computing device;
configuring the camera, depending on the determined characteristic, to transmit video and audio data generated by the camera via a communications interface in two-way full motion duplex to at least one of the user devices; and
receiving user data relating to the one or more auction items from at least one of the plurality of user devices in response to the transmission.

10. The method of claim 9, wherein the user devices comprise a computer device, and wherein the characteristic comprises one of an internet connection, a web enabled camera, computer enabled microphone, and video processing capability.

11. The method of claim 9, wherein the user devices comprise a mobile device, and wherein the characteristic comprises one of an internet connection, a web enabled camera, functional microphone, and video processing capability.

12. The method of claim 9, further comprising configuring the camera to transmit video and audio data generated by the camera in unidirectional full motion duplex to at least one of the user devices depending on the determined characteristic.

13. The method of claim 9, wherein the user data relating to the one or more auction items comprises bidding data.

14. The method of claim 9, further comprising transmitting user data via the communications interface among each of the plurality of user devices.

15. The method of claim 9, wherein the computer network comprises a packet-oriented network.

16. A system for communicating with a plurality of user devices, comprising:
a computing device;
a camera, operatively coupled to the computing device, wherein the camera is configured to capture video and audio data relating to one or more auction items; and
a communications interface, operatively coupled to the computing device, wherein the communications interface is configured to communicate with the plurality of user devices at a predetermined auction time and transmit the captured video and audio data relating to the one or more auction items in real time via a computer network,
wherein the computing device is configured to determine characteristics of the user devices, and, depending on the determined characteristic, configure the camera to transmit video and audio data generated by the camera in two-way full motion duplex to at least one of the user devices,
and wherein the communications interface is configured to receive user data relating to the one or more auction items from at least one of the plurality of user devices in response to the transmission.

17. The system of claim 16, wherein the user devices comprise a computer device, and wherein the characteristic comprises one of an internet connection, a web enabled camera, computer enabled microphone, and video processing capability.

18. The system of claim 16, wherein the user devices comprise a mobile device, and wherein the characteristic comprises one of an internet connection, a web enabled camera, functional microphone, and video processing capability.

19. The system of claim 16, wherein the computing device, depending on the determined characteristic, configures the camera to transmit video and audio data generated by the camera in unidirectional full motion duplex to at least one of the user devices.

20. The system of claim 16, wherein the user data relating to the one or more auction items comprises bidding data.

21. The system of claim 16, wherein the communications interface is configured to transmit user data among each of the plurality of user devices.
